(19) United States
(12) Patent Application Publication
(10) Pub. No.: US 2012/0328017 A1
(43) Pub. Date: Dec. 27, 2012

(54) VIDEO DECODER AND VIDEO DECODING METHOD

(76) Inventor: Yuji Kawashima, Tokyo (JP)

(21) Appl. No.: 13/370,152

(22) Filed: Feb. 9, 2012

(30) Foreign Application Priority Data
Jun. 23, 2011 (JP) 2011-139803

(51) Int. Cl. H04N 7/26

(52) U.S. Cl. 375/240.16; 375/240.25; 375/E07.17; 375/E07.105

(57) ABSTRACT

According to one embodiment, a video decoder includes a detector and an interpolation module. The detector is configured to detect an error in a macroblock contained in stream data including multiview video images. The interpolation module is configured to perform interpolation on a slice including an error-detected macroblock. If the slice is to be decoded with reference to a picture of a same view, the interpolation module performs interpolation on the slice by using a macroblock included in the picture in the same view. If the slice is to be decoded with reference to a picture of a different view, the interpolation module performs interpolation on the slice by using a macroblock comprised in the picture of the different view.

### CROSS-REFERENCE TO RELATED APPLICATIONS

This application is based upon and claims the benefit of priority from Japanese Patent Application No. 2011-139803, filed Jun. 23, 2011, the entire contents of which are incorporated herein by reference.

### FIELD

Embodiments described herein relate generally to a video decoder and a video decoding method.

### BACKGROUND

Conventionally, in video decoders that decode stream data based on the H.264/MVC(Multiview Video Coding), in which H.264/AVC (Advanced Video Coding) is extended to multi-view video, when an error is contained in a macroblock contained in a picture of a certain view and a slice containing this macroblock is damaged, concealment (missing information interpolation) is performed to interpolate and restore the damaged slice on the basis of information on other macroblocks contained in pictures related to the damaged slice in the same view as that of the damaged slice.

However, in the conventional technology, the concealment is performed based on macroblocks contained in temporally different pictures in the same view, so that an image obtained by the concealment is sometimes slightly distorted. In particular, in the H.264/MVC-based stream data, views other than a base view compliant with the H.264/AVC are decoded not only by prediction based on pictures in the same view but also by prediction based on pictures in different views. Therefore, pictures having a large number of macroblocks that are decoded by inter-view prediction have a weak temporal correlation with other pictures. Consequently, image distortion easily occurs in the conventional concealment.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of video containing multiple views according to one embodiment;

FIG. 2 is an exemplary schematic diagram of a picture containing an error-detected block in the embodiment;

FIG. 3 is an exemplary schematic diagram illustrating conventional concealment;

FIG. 4 is an exemplary schematic diagram illustrating concealment in the embodiment;

FIG. 5 is an exemplary block diagram of a configuration of a video decoder in the embodiment;

FIG. 6 is an exemplary flowchart of a concealment process in the embodiment;

FIG. 7 is an exemplary flowchart of selection of an interpolation method in the embodiment;

FIG. 8 is an exemplary schematic diagram of a picture containing an error-detected block in which an error is detected, in the embodiment;

FIG. 9 is an exemplary schematic diagram of a picture that is preceding the picture containing the error-detected block in which the error is detected, in decoding order, in the embodiment;

FIG. 10 is an exemplary flowchart of selection of an interpolation method, in the embodiment;

FIG. 11 is an exemplary schematic diagram of a picture containing an error-detected block in which an error is detected, in the embodiment;

FIG. 12 is an exemplary schematic diagram of a picture that is preceding the picture containing the error-detected block in which the error is detected, in decoding order, in the embodiment; and

FIG. 13 is an exemplary block diagram of a configuration of a video reproducer, in the embodiment.

### DETAILED DESCRIPTION

In general, according to one embodiment, a video decoder comprises: a detector; and an interpolation module. The detector is configured to detect an error in a macroblock contained in stream data comprising multiview video images. The interpolation module is configured to perform interpolation on a slice comprising an error-detected macroblock. If the slice is to be decoded with reference to a picture of a same view, the interpolation module is configured to perform interpolation on the slice by using a macroblock comprised in the picture in the same view. If the slice is to be decoded with reference to a picture of a different view, the interpolation module is configured to perform interpolation on the slice by using a macroblock comprised in the picture of the different view.

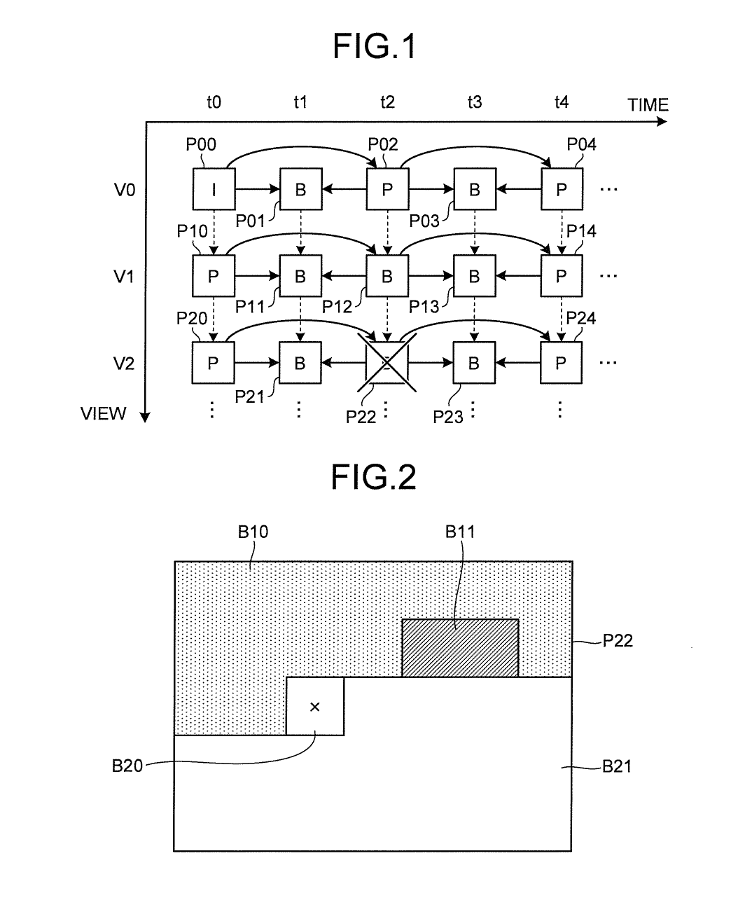

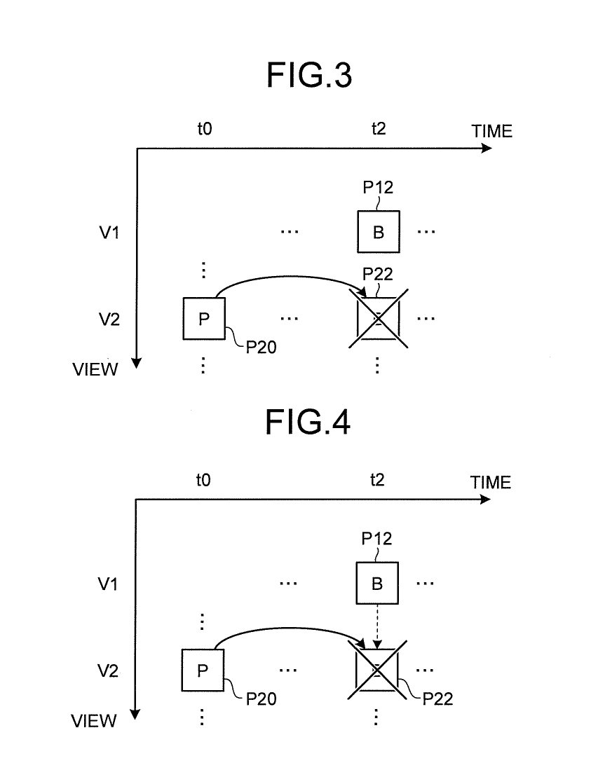

Exemplary embodiments are explained below in detail with reference to the accompanying drawings. First, an outline of an embodiment is explained with reference to FIGS. 1 to 4. FIG. 1 is a schematic diagram illustrating an example of video containing multiple views. FIG. 2 is a schematic diagram illustrating an example of a picture P22 containing an error-detected block B20. FIG. 3 is a schematic diagram illustrating an example of conventional concealment. FIG. 4 is a schematic diagram illustrating an example of concealment according to an embodiment.

As illustrated in FIG. 1, video stream data containing multiple views based on the H.264/MVC or the like is composed of a base view V0 compliant with the H.264/AVC codec standard and non-base views V1 and V2 in which inter-view prediction is performed in addition to coding based on the H.264/AVC codec standard. “I”, “P”, and “B” illustrated in the drawing indicate types of frame pictures. Specifically, “I” indicates an I picture, “P” indicates a P picture, and “B” indicates a B picture. The video stream data in the embodiment is compliant with the H.264/MVC.

Specifically, in the base view V0, as indicated by solid arrows, pictures P00 to P04 corresponding to time t0 to t4 are subjected to inter-frame prediction with reference to pictures in the base view V0 that is the same view. For example, a picture P02 that is the P picture is encoded with reference to a preceding picture P00 that is the I picture, and a picture P01 that is the B picture is encoded with reference to the preceding picture P00 and the subsequent picture P02. The non-base view V1 is subjected to prediction between different views (inter-view prediction) as indicated by dashed-line arrows, in addition to the inter-frame prediction performed in the same view as indicated by the solid arrows. In the following explanation, the prediction (the solid arrows) performed with reference to pictures in the same view or in the same frame is simply referred to as inter-frame prediction, and the prediction (the dashed-line arrows) performed with reference to pictures in different views is referred to as inter-view prediction, for the sake of distinction.

The encoding and decoding in each picture is performed in unit of slice that is composed of a plurality of macroblocks. The stream data contains, as additional information, information on a picture that is referred to when the encoding or decoding is performed in unit of slice, i.e., a picture that is referred to when the inter-frame prediction or the inter-view prediction is performed. Therefore, when video is decoded from the stream data, predictive-encoded image data is decoded with reference to pictures indicated by the solid arrows or the dashed-line arrows.

It is assumed here that, as illustrated in FIG. 1, an error is contained in a macroblock contained in the picture P22. The error may be contained in a macroblock due to noise that occurs during communication of stream data. As an example, whether the error is contained in the macroblock is detected by detecting whether the value of coded block pattern (CBP) in the macroblock becomes suddenly large.

Specifically, as illustrated in FIG. 2, the picture P22 is decoded in raster order, and the error-detected block B20 is a macroblock in which an error is detected. The decoding order of the macroblocks is not limited to the raster order as illustrated in the drawing; alternatively, interleaving or wipe may be used. In the picture P22, a block B10 is a decoded block in which no error is detected, and a block B11 is a block that is decoded in accordance with the inter-view prediction within the block B10. An interpolation target block B21 is a block that contains the error-detected block B20 and that is to be subjected to concealment because the error-detected block B20 is detected. The interpolation target block B21 containing the error-detected block B20 is damaged because of the contained error, so that the interpolation target block B21 cannot be decoded in accordance with the prediction. Therefore, concealment is performed to interpolate and restore the damaged slice on the basis of information on other macroblocks. In the example illustrated in the drawing, the interpolation target block B21 containing the error-detected block B20 is provided as one slice composed of the rest part of the picture P22; however, it is of course possible to divide the block into a plurality of slices.

Conventionally, concealment on the interpolation target block B21 containing the error-detected block B20 is performed with reference to a macroblock contained in the same view as illustrated in FIG. 3. Specifically, the interpolation target block B21 of the picture P22 is interpolated with a macroblock in a picture P20 in the same view V2 that is referred to in the inter-frame prediction. On the other hand, in the concealment according to the embodiment, a block that is decoded with reference to a picture in a different view is interpolated with a macroblock in a picture that is in the different view and that is referred to in the inter-view prediction.

Specifically, as illustrated in FIG. 4, the interpolation target block B21 of the picture P22 is interpolated with a macroblock in a picture P12 in the different view V1 that is referred to in the inter-view prediction. In this way, the interpolation target block B21 that is to be decoded with reference to the picture P12 in the different view is interpolated with a macroblock in the picture P12 that is referred to in the inter-view prediction. Therefore, correlation between the macroblocks that are interpolated by the concealment is increased, so that image distortion is not likely to occur. Meanwhile, the inter-view prediction is not performed on a slice that contains a macroblock in which an error is detected within the base view V0 compliant with the H.264/AVC codec standard; therefore, such a slice is interpolated with reference to a macroblock contained in a picture in the same view as in the conventional manner.

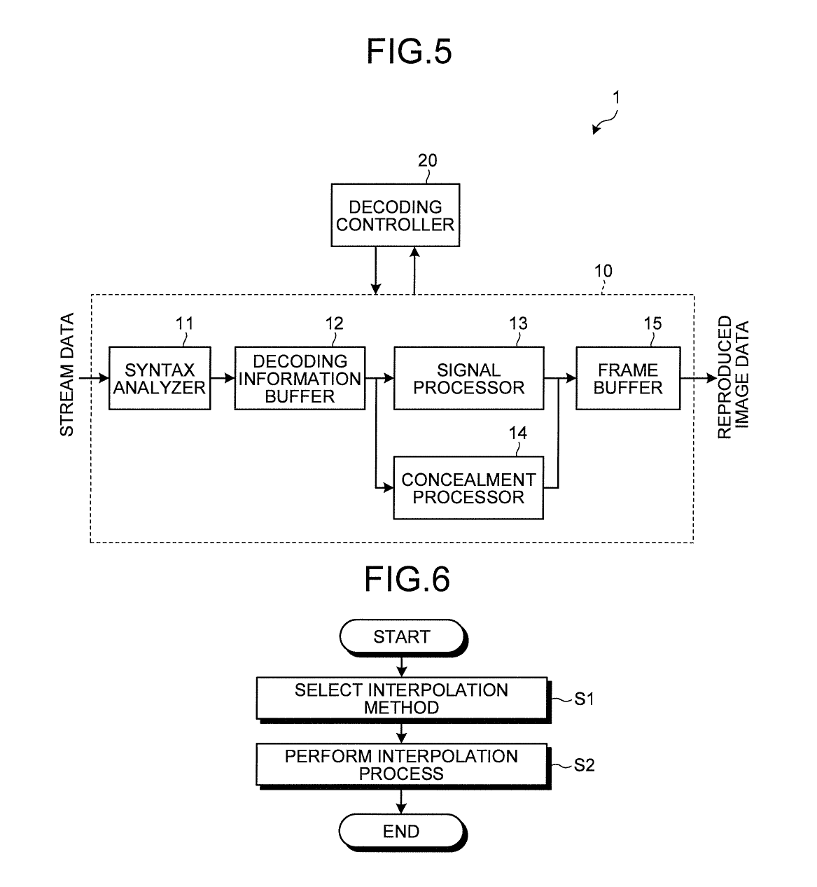

A video decoder in the embodiment that performs the above concealment is explained below. FIG. 5 is a block diagram of a configuration of a video decoder 1 in the embodiment.

As illustrated in FIG. 5, the video decoder 1 is a digital signal processor (DSP) or the like that decodes H.264/MVC-based stream data and outputs reproduced image data. Specifically, the video decoder 1 comprises a decoding module 10 that receives H.264/MVC-based stream data and outputs reproduced image data and a decoding controller 20 that controls the decoding module 10. The decoding module 10 comprises a syntax analyzer 11, a decoding information buffer 12, a signal processor 13, a concealment processor 14, and a frame buffer 15.

The syntax analyzer 11 receives input of the H.264/MVC-based stream data, analyzes the stream data in accordance with a predetermined system (in the embodiment, the system compliant with the H.264/MVC), and generates decoding information. The decoding information is, for example, encoded image data contained in a video coding layer (VCL) or a network abstraction layer (NAL) of the stream data, or additional information used to decode the encoded data. The generated decoding information is output to and stored in the decoding information buffer 12.

The syntax analyzer 11 detects presence or absence of an error in a macroblock by, for example, checking the number of CBPs of the macroblock contained in the encoded data of the decoding information. When the syntax analyzer 11 detects an error in the macroblock, the decoding controller 20 is notified of the presence of an error in the macroblock and information indicating the position of the macroblock in the picture. The error in the macroblock may be detected in any detection method other than checking the value of CBP. For example, an error may be detected on the basis of whether the length of skip_run inserted in the head of each macroblock exceeds a preset upper-limit length.

The decoding information buffer 12 temporarily stores therein the decoding information output by the syntax analyzer 11. The decoding information stacked in the decoding information buffer 12 is output to the signal processor 13 or the concealment processor 14 under the control of the decoding controller 20. The signal processor 13 receives input of the decoding information from the decoding information buffer 12 and performs signal processing to decode the encoded data in accordance with a predetermined system (in the embodiment, the system compliant with the H.264/MVC), on the basis of the received decoding information. The decoded data, i.e., the decoded slice, is output to and stored in the frame buffer 15.

The concealment processor 14 performs a concealment process on the slice containing the macroblock in which the error is detected, under the control of the decoding controller 20 (details will be described later). The slice interpolated by the concealment process is output to and stored in the frame buffer 15. The frame buffer 15 temporarily stores therein data of a frame image that is composed of slices output from the signal processor 13 and the concealment processor 14. The frame image that is temporarily stored in the frame buffer 15 is output as reproduced image data, under the control of the decoding controller 20 triggered by, for example, decoding of an instantaneous decoder refresh (IDR) picture. Upon output of the reproduced image data, the data temporarily stored in the decoding information buffer 12 and the frame buffer 15 is deleted.

The decoding controller 20 controls decoding of the stream data by the decoding module 10, by referring to the decoding information that is temporarily stored in the decoding information buffer 12 or information related to the error in the macroblock notified by the syntax analyzer 11. Specifically, the decoding controller 20 checks whether a macroblock in a slice to be decoded contains an error, on the basis of the information indicating the position of the macroblock in which the error is detected. When the error is not contained, the decoding controller 20 reads the decoding information corresponding to the slice to be decoded from the decoding information buffer 12 and outputs the decoding information to the signal processor 13. When the error is contained, the decoding controller 20 activates the concealment processor 14 and outputs the decoding information corresponding to the slice that contains the error-detected macroblock to the concealment processor 14.

Details of the concealment process performed by the concealment processor 14 is explained below. FIG. 6 is a flowchart illustrating an example of the concealment process.

As illustrated in FIG. 6, when the concealment processor 14 is activated by the decoding controller 20 and starts the concealment process, the concealment processor 14 selects an interpolation method for interpolating a slice containing an error-detected macroblock on the basis of the decoding information corresponding to the slice containing the error-detected macroblock (S1). Specifically, the concealment processor 14 refers to the additional information contained in the decoding information, and, when the slice containing the error-detected macroblock is a slice that has been encoded by the inter-frame prediction and that is to be decoded by the inter-frame prediction, the concealment processor 14 selects an interpolation method that refers to a macroblock contained in a picture in the same view, i.e., a conventional interpolation method compliant with the H.264/AVC codec standard (intra-view interpolation). When the slice containing the error-detected macroblock is a slice that has been encoded by the inter-view prediction and that is to be decoded by the inter-view prediction, the concealment processor 14 selects an interpolation method that refers to a macroblock contained a picture in a different view (inter-view interpolation). Subsequently, the concealment processor 14 performs an interpolation process for interpolating the slice containing the error-detected macroblock by using the selected interpolation method (S2).

At S1, the interpolation method may be selected on the basis of a prediction method applied to a macroblock that is decoded prior to the error-detected macroblock, i.e., on the basis of a prediction method applied to a macroblock that has been decoded in the past. Specifically, when the number of macroblocks that have been decoded in the past by the inter-view prediction as the prediction method is large, it may be possible to select the interpolation method that refers to a macroblock contained in a picture in a different view.

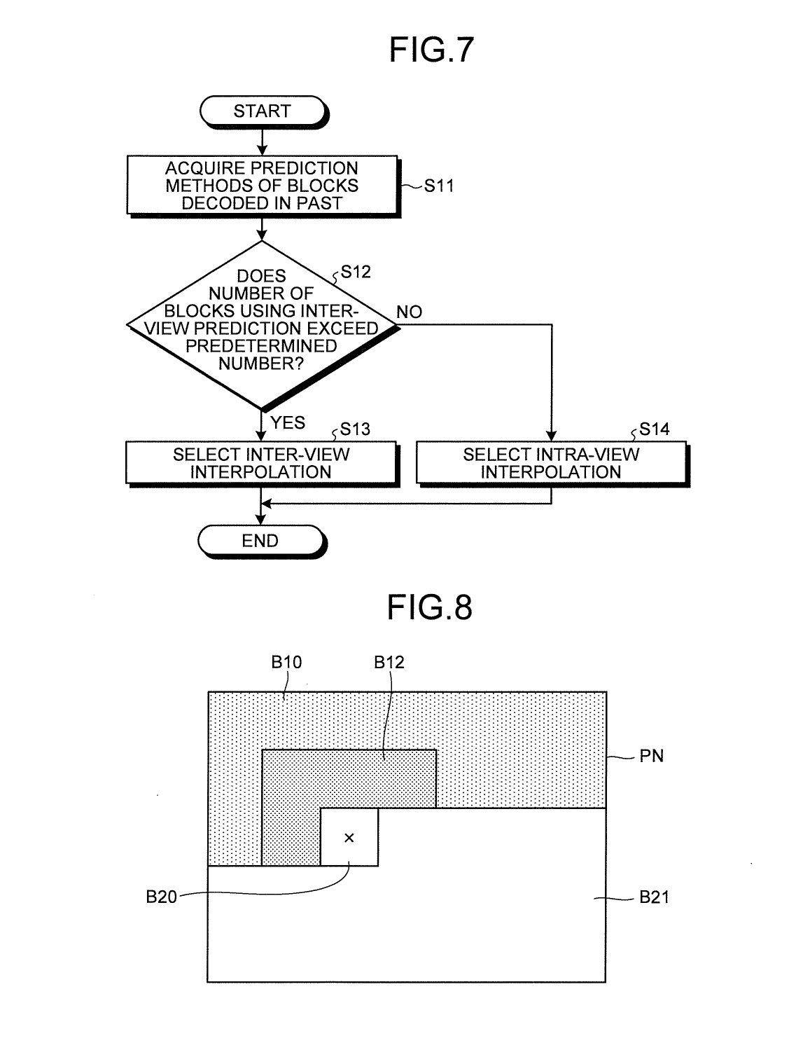

FIG. 7 is a flowchart illustrating an example of selection of the interpolation method. As illustrated in FIG. 7, the decoding controller 20 acquires prediction methods of blocks that have been decoded in the past, by referring to the additional information that is temporarily stored in the decoding information buffer 12 (S11). Subsequently, the decoding controller 20 determines whether the number of macroblocks using the inter-view prediction that is performed between different views is large and exceeds a predetermined number (S12). When the number of the macroblocks using the inter-view prediction exceeds the predetermined number (Yes at S12), the decoding controller 20 selects the inter-view interpolation and causes the concealment processor 14 to perform the inter-view interpolation (S13). When the number of the macroblocks using the inter-view prediction does not exceed the predetermined number (No at S12), the decoding controller 20 selects the intra-view interpolation and causes the concealment processor 14 to perform the intra-view interpolation (S14).

In this way, when the number of macroblocks that have been decoded by the inter-view prediction among the macroblocks that have been decoded in the past is greater than the predetermined number, because there is a strong correlation with a picture in a different view, the interpolation method that refers to a macroblock contained in the picture in the different view is selected. Therefore, image distortion caused by the concealment process performed by the concealment processor 14 is less likely to occur.

A range of the macroblocks that have been decoded in the past and that are to be referred to according to the additional information may be composed of all macroblocks preceding and including a macroblock immediately subsequent to a macroblock whose data has been deleted from the decoding information buffer 12 in response to the latest IDR picture, or may be composed of selected macroblocks that have a strong correlation with the error-detected macroblock. Specifically, as illustrated in FIG. 8, the macroblock to be referred to may be an adjacent block B12 that is already decoded and is located near the error-detected block B20 in which the error is detected in a picture PN containing the error-detected block B20 in which the error is detected, or the block B10 that is already decoded in the picture PN containing the error-detected block B20 in which the error is detected.

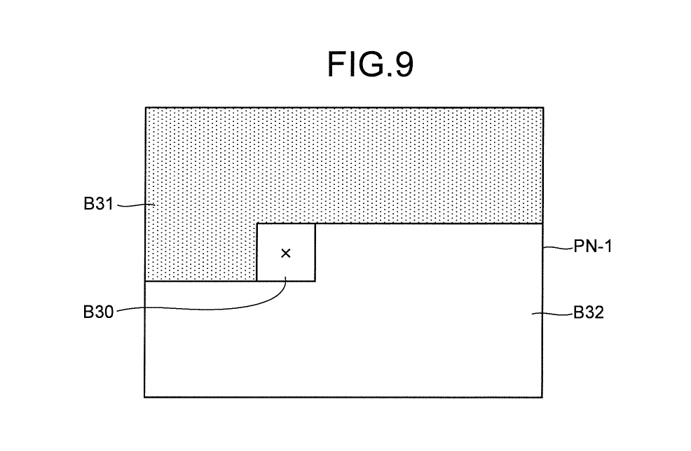

Furthermore, as illustrated in FIG. 9, the macroblock to be referred to may be any of a block B30 located at a position corresponding to the position of the error-detected block B20 in a picture PN-1 that is decoded prior to the picture PN containing the error-detected block B20 in which the error is detected, a block B31 that is a slice preceding the block B30, a block B32 that is a slice containing the block B30, and all of macroblocks (the block B31 and the block B32) contain in the picture PN-1.

Alternatively, at S1, the interpolation method may be selected such that, when a motion-compensated residual signal, which indicates the magnitude of motion compensation and which is obtained on the basis of a motion vector of a macroblock that is decoded by the inter-view prediction within a macroblock that is decoded prior to the error-detected macroblock, i.e., within a macroblock that has been decoded in the past, is smaller than a preset value, the interpolation method that refers to a macroblock contained in a picture in a different view may be selected. The motion vector and the motion-compensated residual signal are calculated when the signal processor 13 performs the signal processing to decode the encoded data (macroblock), and are temporarily stored in the frame buffer 15 together with an index that indicates the position of the macroblock.

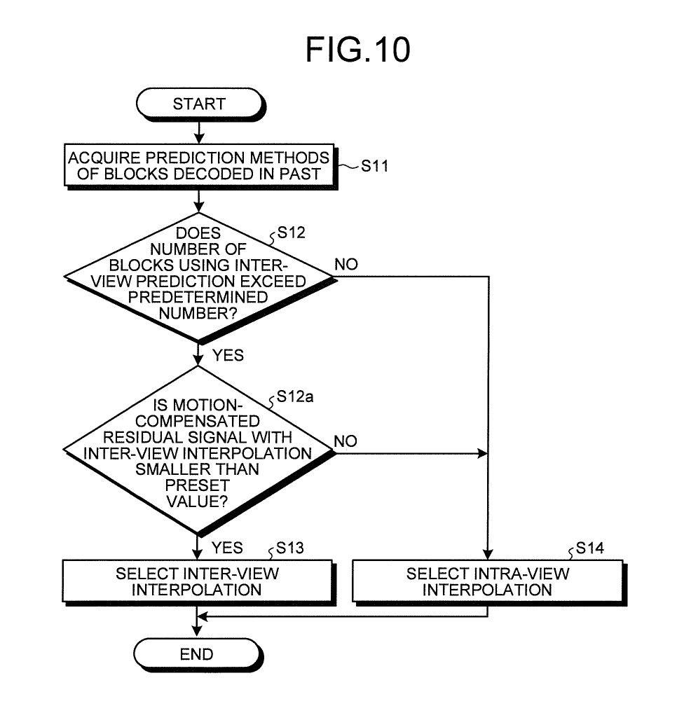

FIG. 10 is a flowchart illustrating an example of selection of an interpolation method. As illustrated in FIG. 10, when the number of the macroblocks using the inter-view prediction exceeds the predetermined number (Yes at S12), the decoding controller 20 determines whether a motion-compensated residual signal that is temporarily stored in the frame buffer 15 for these macroblocks is smaller than a preset value (S12a). When the motion-compensated residual signal is smaller than the preset value (Yes at S12a), the decoding controller 20 selects the inter-view interpolation and causes the concealment processor 14 to perform the inter-view interpolation (S13). When the motion-compensated residual signal is not smaller than the preset value (No at S12a), the decoding controller 20 selects the intra-view interpolation and causes the concealment processor 14 to perform the intra-view interpolation (S14).

In this way, when the magnitude of the motion compensation of the macroblock that is decoded by the inter-view prediction among the macroblocks that have been decoded in the past is small, because there is a strong correlation with a picture in a different view, the interpolation method that refers to a macroblock contained in the picture in the different view is selected. Therefore, image distortion caused by the concealment process performed by the concealment processor 14 is less likely to occur.

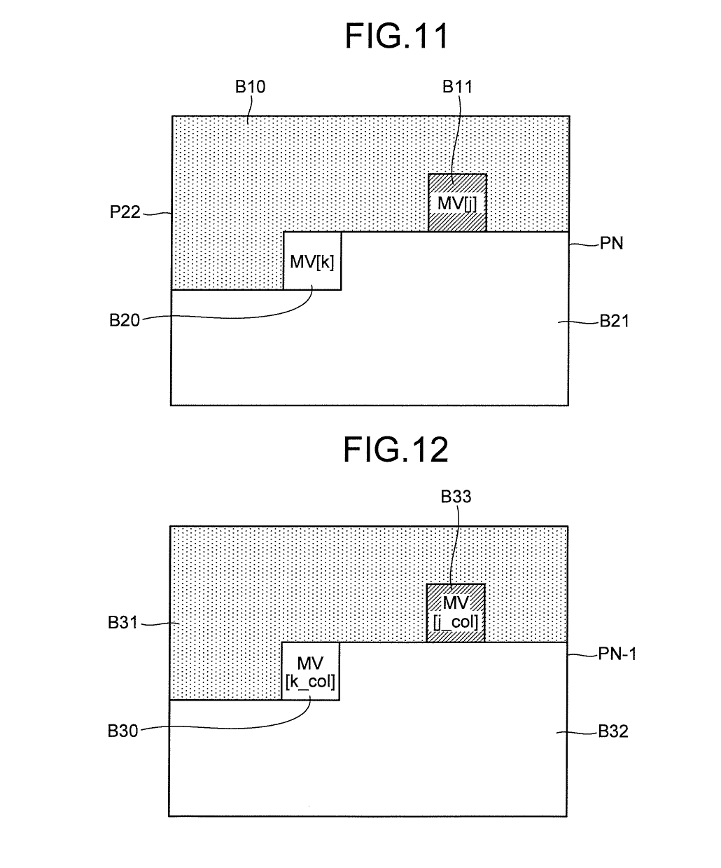

An interpolation process performed by the concealment processor 14 for interpolating a slice containing an error-detected macroblock is explained below. The intra-view interpolation is performed by using the conventional interpolation method that is compliant with the H.264/AVC codec standard; therefore, only the interpolation process related to the inter-view interpolation is explained below with reference to FIGS. 11 and 12. FIG. 11 is a schematic diagram illustrating an example of a picture containing the error-detected block B20 in which the error is detected. FIG. 12 is a schematic diagram illustrating an example of the picture PN-1 that is preceding the picture PN containing the error-detected block B20 in which the error is detected, in decoding order.

When the inter-view interpolation is to be performed, the concealment processor 14 determines motion vectors in all of macroblocks contained in an interpolation target block, and performs interpolation on the interpolation target block by referring to the macroblocks corresponding to the determined motion vectors. As illustrated in FIG. 11, it is assumed that a motion vector of the error-detected block B20 in which the error is detected (and which is the interpolation target block) is MV [k], and a motion vector of the block B11 that is decoded by the inter-view prediction is MV[j]. As illustrated in FIG. 12, it is also assumed that, in the picture PN-1, a motion vector of a block B30 corresponding to the position of the error-detected block B20 is MV[k_col], and a motion vector of a block B33 corresponding to the position of the block B11 is MV[jcol].

In this case, the concealment processor 14 reads a value of the motion vector MV[k_col] (first motion compensation information) of the block B30 corresponding to the position of the error-detected block B20, from the frame buffer 15, and uses the read value as the motion vector MV[k] of the error-detected block B20. Specifically, it is possible to calculate such that MV[k]=MV[kcol], which will be described as Expression (A). In this case, because MV[k_col] that possibly has a strong correlation with the motion vector MV [k] is used, image distortion due to the interpolation is less likely to occur.

Furthermore, the concealment processor 14 reads the MV[k_col] from the frame buffer 15 and performs scaling (correction) on MV[k_col], on the basis of the value of the motion vector MV[j] (second motion compensation information) of the block B11 that is already decoded in the picture PN containing the error-detected block B20 in which the error is detected, and on the basis of the value of the motion vector MV[j_col] (third motion compensation information) of the block B33 located at a position corresponding to the position of the block B11 in the picture PN-1, and then uses the scaled value as the motion vector MV[k] of the error-detected block B20. Specifically, it is possible to calculate such that MV[k]=MV[k_col]×MV[j]/MV[j_col], which will be described as Expression (B). In this case, it becomes possible to improve the accuracy of the value to be used as the motion vector MV[k] of the error-detected block B20.

Assuming that MV[k] in Expression (A) is MVA while MV[k] in Expression (B) is MVB, it is possible to calculate such that MV[k]=(1−α)×MVA+α×MVB. Here, a takes a value in the range 0 to 1. α may be a ratio R[k_col]/R[j_col] between the magnitudes of the residual signals of the motion compensation in the block B30 having MV[k_col] and in the block B33 having MV[j_col] (the residual signals are R[k_col] and R[j_col], respectively).

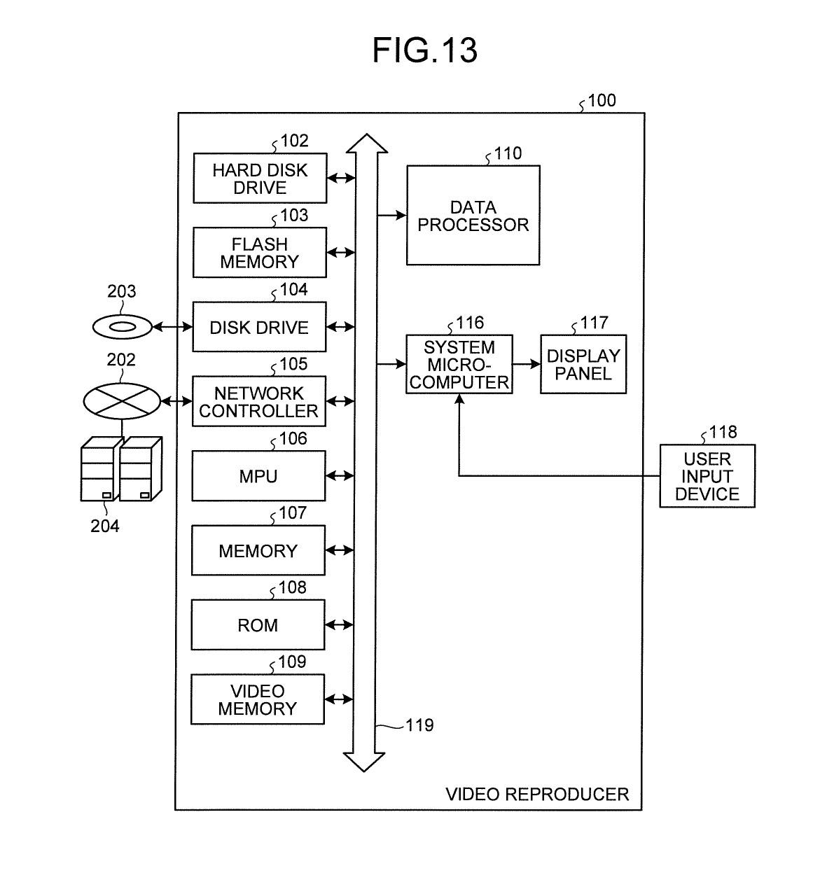

A video decoder is explained below as an example of an electronic equipment using the video decoder 1. FIG. 13 is a block diagram of a configuration of a video reproducer 100.

As illustrated in FIG. 13, the video reproducer 100 comprises a data processor 110 that performs processes as the video decoder 1. Specifically, the video reproducer 100 uses a recording medium 203, such as an optical disk, to read video contents data (data for reproducing video contents, such as movie or drama) that is recorded in the recording medium 203 in a digital format, and reproduce video contents and interactive data (menu data, animation data, or sound effect data that is reproduced in connection with the video data, contents explanation data, such as explanation of the video contents, or data containing questions used in quiz). The video reproducer 100 is connected to a network storage 204 via the Internet 202 to acquire the video contents data from the network storage 204 and reproduce the video contents and the interactive data.

The video reproducer 100 comprises a hard disk drive 102, a flash memory 103, a disk drive 104, and a network controller 105. They are connected to a bus 119. The hard disk drive 102 records digital data, such as the video contents data, in a magnetic disk that rotates at high speed, and performs read and write of the digital data. The flash memory 103 stores therein digital data, such as the video contents data, to allow for read and write of the digital data. The disk drive 104 has a function of reading the digital data, such as the video contents data, from the recording medium 203 and outputting a reproduction signal. The network controller 105 controls read and write of the digital data, such as the video contents data, from and to the network storage 204 via the Internet 202.

The video reproducer 100 further comprises a micro processing unit (MPU) 106, a memory 107, a ROM 108, and a video memory 109. They are connected to the bus 119. The MPU 106 is activated in accordance with an activation program that is read onto the memory 107 from the ROM 108. The MPU 106 reads a player program from the ROM 108 onto the memory 107 and controls system initialization, system termination, or the like, in accordance with the player program, thereby controlling processes performed by a system microcomputer 116. Furthermore, the MPU 106 instructs the data processor 110, which will be described below, to reproduce video and audio from the video contents data read from any of the recording medium 203, the network storage 204, the hard disk drive 102, and the flash memory 103. The memory 107 stores there in data and programs that are used when the MPU 106 operates. The ROM 108 stores therein programs, such as the activation program and the player program, executed by the MPU 106, programs executed by the data processor 110 (e.g., a video reproduction program for decoding compression-coded video audio data, such as the video contents data, and for reproducing video and audio), permanent data, and the like. In the video memory 109, decoded reproduced image data to be described below is sequentially written.

The data processor 110 operates in accordance with the video reproduction program, to thereby separate the compressed and coded video audio data into video data and audio data, decode the video data and the audio data, and reproduce video and audio. The system microcomputer 116 displays video-contents reproduction information on a display panel 117 and inputs an operation input signal that is input by a user input device 118 (a device that allows for input of operation, such as a remote controller or an operation button provided in the video reproducer 100). The display panel 117 comprises a liquid crystal display panel and displays various types of information related to reproduction of the video contents and the interactive data on the liquid crystal display panel, in accordance with an instruction of the system microcomputer 116.

The program executed by the video decoder 1 in the embodiment are provided as being stored in a computer-readable recording medium, such as a compact disc-read only memory (CD-ROM), a flexible disk (FD), a compact disc recordable (CD-R), a digital versatile disk (DVD), as a file in an installable or executable format.

The program executed by the video decoder 1 in the embodiment may be stored in a computer connected via a network, such as the Internet, so that they can be downloaded therefrom via the network. Furthermore, the program executed by the video decoder 1 may be provided or distributed via a network, such as the Internet.

The program executed by the video decoder 1 in the embodiment has a module structure comprising the modules described above. A CPU (processor) as actual hardware reads the program from the ROM described above and executes the program, so that the modules described above are loaded on a main storage device and provided on the main storage device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video decoder comprising:
a detector configured to detect an error in a macroblock contained in stream data comprising multiview video images; and
an interpolation module configured to perform interpolation on a slice comprising an error-detected macroblock, wherein,
if the slice is to be decoded with reference to a picture of a same view, the interpolation module is configured to perform interpolation on the slice by using a macroblock comprised in the picture in the same view, and,
if the slice is to be decoded with reference to a picture of a different view, the interpolation module is configured to perform interpolation on the slice by using a macroblock comprised in the picture of the different view.

2. The video decoder of claim 1, wherein,
if, among macroblocks decoded before the error-detected macroblock, the number of macroblocks which are each decoded with reference to a picture of a different view exceeds a predetermined number, the interpolation module is configured to perform interpolation by using a macroblock comprised in a picture of a different view, and,
if the number of macroblocks does not exceed the predetermined number, the interpolation module is configured to perform interpolation by using a macroblock of a picture of a same view.

3. The video decoder of claim 1, wherein, if a value indicating magnitude of motion compensation of a macroblock that is decoded with reference to a picture in a different view and decoded before the error-detected macroblock is smaller than a preset value, the interpolation module is configured to perform interpolation by using a macroblock comprised in a picture in a different view.

4. The video decoder of claim 2, wherein the macroblocks that are decoded before the error-detected macroblock are at least one of: a macroblock that is already decoded and is located near the error-detected macroblock; a macroblock that is already decoded in a picture comprising the error-detected macroblock; a macroblock at a position corresponding to a position of the error-detected macroblock in a picture that is decoded before the picture comprising the error-detected macroblock; and all of macroblocks in a picture that is decoded before the picture comprising the error-detected macroblock.

5. The video decoder of claim 3, wherein the macroblock that is decoded before the error-detected macroblock are at least one of: a macroblock that is already decoded and is located near the error-detected macroblock; a macroblock that is already decoded in a picture comprising the error-detected macroblock; a macroblock at a position corresponding to a position of the error-detected macroblock in a picture that is decoded before the picture comprising the error-detected macroblock; and all of macroblocks in a picture that is decoded before the picture comprising the error-detected macroblock.

6. The video decoder of claim 1, wherein the interpolation module is configured to perform interpolation by using a macroblock comprised in a picture of a different view, on the basis of first motion compensation information indicating motion compensation of a macroblock located at a position, which corresponds to a position of the error-detected macroblock, in a picture that is decoded before the picture comprising the error-detected macroblock.

7. The video decoder of claim 6, wherein the interpolation module is configured to correct the first motion compensation information on the basis of second motion compensation information and third motion compensation information, the second motion compensation information indicating motion compensation of an error-detected macroblock that is already decoded in the picture comprising the error-detected macroblock, the third motion compensation information indicating motion compensation of the macroblock located at a position, which corresponds to the position of the decoded macroblock, in a picture that is decoded before the picture comprising the error-detected macroblock.

8. A video decoding method implemented by a video decoder, the video decoding method comprising:
detecting, by a detector, an error in a macroblock contained in stream data comprising multiview video images; and
performing, by an interpolation module, interpolation on a slice comprising an error-detected macroblock, wherein,
if the slice is to be decoded with reference to a picture of a same view, the interpolation module performs interpolation on the slice by using a macroblock comprised in the picture in the same view, and, if the slice is to be decoded with reference to a picture of a different view, the interpolation module performs interpolation on the slice by using a macroblock comprised in the picture of the different view.
